(19) United States
(12) Patent Application Publication
(10) Pub. No.: US 2021/0191952 A1
(43) Pub. Date: Jun. 24, 2021

(54) HUMAN-MACHINE DIALOG METHOD AND APPARATUS, AND DEVICE

(71) Applicant: Beijing Baidu Netcom Science Technology Co., Ltd., Beijing (CN)

(72) Inventors: Xiaonan HE, Beijing (CN); Chao YIN, Beijing (CN); Qiang JU, Beijing (CN); Jian XIE, Beijing (CN)

(21) Appl. No.: 17/085,551

(22) Filed: Oct. 30, 2020

(30) Foreign Application Priority Data
Jun. 2, 2020 (CN) 202010487974.2

(51) Int. Cl. G06F 16/2457; G06F 16/2458; G06F 16/9032

(52) U.S. Cl. CPC G06F 16/24578; G06F 2216/03; G06F 16/90332; G06F 16/2465

(57) ABSTRACT

The present application discloses a human-machine dialog method, an apparatus, and a device. The specific implementation solution includes: acquiring a first query by a user, and perform semantic parsing on the first query to obtain a first key information set; acquiring a second key information set corresponding to at least one historical query; determining a plurality pieces of candidate semantics of the query according to the first key information set and the second key information set, and generating a response query corresponding to the first query according to the plurality pieces of candidate semantics. In the above process, the plurality pieces of candidate semantics of the user are determined according to the first key information set and the second key information set, the accuracy of user semantic understanding is improved, hence, a more reasonable response can be output to the user, and the user session experience is improved.

### CROSS-REFERENCE TO RELATED APPLICATIONS

This application claims priority to Chinese Patent Application No. 202010487974.2, filed on Jun. 2, 2020 and entitled “HUMAN-MACHINE DIALOG METHOD AND APPARATUS, AND DEVICE”, the content of which is hereby incorporated by reference in its entirety.

### TECHNICAL FIELD

Embodiments of the present application relate to the field of natural language processing in data processing, and in particular, to a human-machine dialog method and apparatus, and a device.

### BACKGROUND

In a human-machine dialog scenario, an intent of a user may need to go through multiple rounds of dialogs to be expressed clearly. Therefore, in some scenarios, it is necessary to combine an expression input by the user in a current round with an expression input in a previous round so as to accurately understand the intent of the user.

In prior art, when the expression input by the user is obtained, subject-predicate-object components of the expression in the current round are detected through a preset rule, and whether the expression in the current round is in an omission form or not is judged. When the expression in the current round is in the omission form, the expression in the current round is combined with the expression in the previous round to understand to determine the intent of the user. When the expression in the current round is in a non-omission form, the expression in the current round is independently understood to determine the intent of the user.

However, the above method still has a problem of inaccurate user semantic understanding, which results in low session efficiency and reduced session experience of the user.

### SUMMARY

Embodiments of the present application provide a human-machine dialog method and apparatus, and a device to improve accuracy of user semantic understanding and user session experience.

A first aspect of the present application provides a human-machine dialog method, where the method includes:
acquiring a first query by a user, and performing semantic parsing on the first query to obtain a first key information set, where the first key information set includes at least one piece of first key information;
acquiring a second key information set corresponding to at least one historical query, where the second key information set includes at least one piece of second key information;
determining a plurality pieces of candidate semantics corresponding to the first query according to the first key information set and the second key information set; and
generating a response query corresponding to the first query according to the plurality pieces of candidate semantics.

A second aspect of the present application provides a human-machine dialog apparatus, where the apparatus includes:
an acquiring unit configured to acquire a first query by a user, and perform semantic parsing on the first query to obtain a first key information set, where the first key information set includes at least one piece of first key information;
the acquiring unit is further configured to acquire a second key information set corresponding to at least one historical query, where the second key information set includes at least one piece of second key information;
a determining unit configured to determine a plurality pieces of candidate semantics corresponding to the first query according to the first key information set and the second key information set; and
a generating unit configured to generate a response query corresponding to the first query according to the candidate semantics.

A third aspect of the present application provides an electronic device, where the device includes:
at least one processor; and
a memory communicatively coupled to the at least one processor, where the memory stores instructions executable by the at least one processor, the instructions are executed by the at least one processor to cause the at least one processor to perform the human-machine dialog method according to any of the first aspect.

A fourth aspect of the present application provides a non-transitory computer readable storage medium having computer instructions stored thereon, the computer instructions are configured to cause a computer to perform the human-machine dialog method according to any of the first aspect.

According to the human-machine dialog method, apparatus and device of the embodiments of the present application, the method includes: acquiring a first query by a user, and perform semantic parsing on the first query to obtain a first key information set; acquiring a second key information set corresponding to at least one historical query; determining a plurality pieces of candidate semantics of the query according to the first key information set and the second key information set, and generating a response query corresponding to the first query according to the plurality pieces of candidate semantics. In the above process, the plurality pieces of candidate semantics of the user are determined according to the first key information set and the second key information set, the accuracy of user semantic understanding is improved, hence, a more reasonable response can be output to the user, and the user session experience is improved.

It should be appreciated that statements in this section are not intended to identify key features or essential features of embodiments of the present application, nor are they intended to limit scope of the present application. Other features of the present application will be readily apparent from descriptions of the embodiments.

### BRIEF DESCRIPTION OF DRAWINGS

The drawings are included to provide a better understanding of technical solutions of the present application and are not to be construed as limitations of the present application.

FIG. 1 is a schematic view of a possible application scenario according to an embodiment of the present application;

FIG. 2 is a schematic view for analyzing and processing an expression input by a user according to an embodiment of the present application;

FIG. 3 is a schematic flowchart of a human-machine dialog method according to an embodiment of the present application;

FIG. 4 is a schematic flowchart of another human-machine dialog method according to an embodiment of the present application;

FIG. 5 is a schematic view of a generating process for a key information co-occurrence database according to an embodiment of the present application;

FIG. 6 is a schematic view of a process for human-machine dialog processing according to an embodiment of the present application;

FIG. 7 is a structural diagram of a human-machine dialog apparatus according to an embodiment of the present application; and

FIG. 8 is a structural diagram of an electronic device according to an embodiment of the present application.

### DESCRIPTION OF EMBODIMENTS

To describe technical solutions in embodiments of the present application more clearly, the embodiments are described in accompany with drawings. Apparently, the following descriptions illustrate merely some embodiments of the present application. Therefore, a person of ordinary skill in the art will recognize that various changes and modifications of the embodiments described herein can be made without departing from the scope and the spirit of the present application. Also, descriptions of well-known functions and constructions are omitted in the following for clarity and conciseness.

A human-machine dialog apparatus has been widely used. The human-machine dialog apparatus can also be called a dialog artificial intelligence system. The human-machine dialog apparatus can achieve multiple function operations (such as an audio-visual entertainment, an information query, a life service, travel road conditions query and the like) in an interaction manner by virtue of natural language dialogs. The human-machine dialog apparatus also has an artificial intelligence capability. In an interaction with a user, the human-machine dialog apparatus continuously learns and evolves to know preferences and habits of the user and gets smarter.

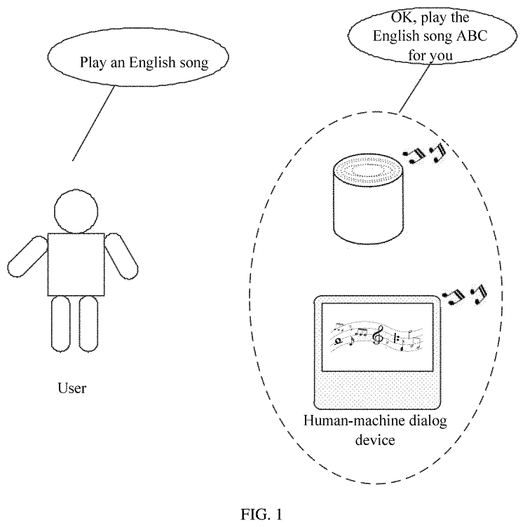

FIG. 1 is a schematic view for explaining a possible scenario according to an embodiment of the present application. As shown in FIG. 1, the scenario includes a human-machine dialog apparatus and a user. For example, the user may input an expression into the human-machine dialog apparatus to express his intent or need. The human-machine dialog apparatus performs analysis, retrieval and the like on the input expression and outputs a response to the user so as to meet his intent or need. For example, when the user asks the human-machine dialog apparatus to play an English song, the human-machine dialog apparatus outputs “OK, play the English song ABC for you” to the user, and the human-machine dialog apparatus starts playing the English song ABC for the user.

It should be noted that, in some scenarios, the expression input by the user to the human-machine dialog apparatus may also be referred to as “query”. In the descriptions of subsequent embodiments, “expression” and “query” are to be understood equivalently.

In the embodiments of the present application, the human-machine dialog apparatus may be any electronic device having a human-machine interaction function. The human-machine dialog apparatus may also be referred to as an intelligent robot or an artificial intelligence assistant, etc. The human-machine dialog apparatus may include but is not limited to: a computer, a smart mobile phone, an intelligent house, an intelligent audio amplifier, an intelligent visual audio amplifier, an intelligent onboard device, an intelligent wearable device, etc.

In the scenario shown in FIG. 1, there may be multiple interaction manners between the user and the human-machine dialog apparatus, which is not limited in the embodiment. Illustratively, the user may interact with the human-machine dialog apparatus in a voice form and may also interact with the human-machine dialog apparatus in a text form. In some scenarios, the user may also interact with the human-machine dialog apparatus using body language.

In some scenarios, the human-machine dialog apparatus can also be in a communicational connection with a server. Therefore, after collecting the expression input by the user, the human-machine dialog apparatus can send the expression to the server which in turn performs analysis and processing so as to obtain the response corresponding to the expression. Then the server returns the response to the human-machine dialog apparatus, and the human-machine dialog apparatus outputs the response to the user.

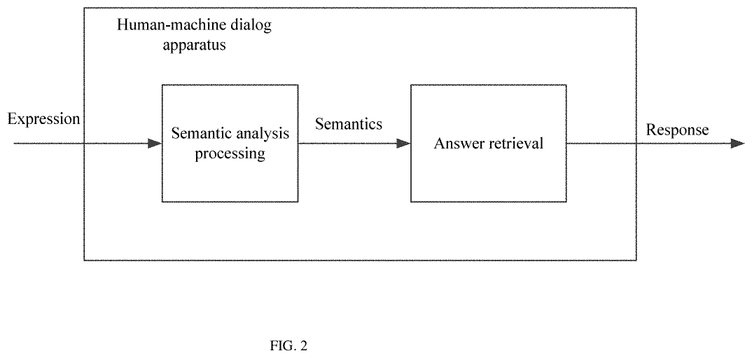

FIG. 2 is a schematic view for analyzing and processing an expression input by a user according to an embodiment of the present application. As shown in FIG. 2, after collecting an expression input by a user, a human-machine dialog apparatus performs semantic parsing on the input expression to determine semantics of the expression, further performs retrieval according to the semantics, and generates a response according to the retrieved answer and outputs the response to the user.

In a semantic parsing process, a Natural Language Understanding (NLU) model may be used. The NLU model is used to perform semantic understanding on an expression to obtain an NLU parsing result. The NLU parsing result include a domain, an intent and a slot. The domain is used for representing a field corresponding to the expression input by the user. The intent is used for representing a purpose expressed by the expression input by the user, and the slot is used for representing key information used for describing the intent in the expression input by the user.

For example, suppose that the expression input by the user is “please play an English song”. When NLU parsing is performed on the expression, a parsing result is obtained as: the domain=music, the intent=play music, the slot=[language of the song-English].

Furthermore, the human-machine dialog apparatus retrieves in a database according to the NLU parsing result to find a song matched with the NLU parsing result, and generates the response according to the retrieval result. For example, suppose that the English song which the human-machine dialog apparatus has retrieved is “ABC”. The response generated by the human-machine dialog apparatus is “OK, play the English song ABC for you”. Thus the human-machine dialog apparatus plays the song for the user.

Typically, semantics of an expression input by the user is relatively complete, such as: “play an English song”, “I want to listen to a song by Xiao Hong”, etc. The subject-predicate-object components of these expressions are complete, and the semantics can be accurately understood according to the expressions.

However, in many cases, when the user expresses a requirement, the user may often use an omission form to express the requirement in the following sessions because the user has previously expressed to listen to music or the human-machine dialog apparatus is playing music. The omission form, i.e. an absence of key objects or other expression components in the expression, which renders it impossible to determine its full intent by the expression per se. For example, the key object “song” is omitted in these expressions, including “change popular”, “do not like this”, “want Chinese”, etc. That is, the expression input by the user in a current round is added with a new requirement on the basis of the expression in a previous round, or a previous requirement is modified.

It can be seen that in some cases it is necessary to understand the expression in the current round in relation to the expression in the previous round, i.e. to understand session semantics of the user in relation to a context. There is a problem that sometimes the expression in the current round and the expression in the previous round are semantically related and need to be understood in connection. But sometimes the expression in the current round and the expression in the previous round are not semantically related and should be understood separately.

In the prior art, in order to accurately understand an intent of a user, when an expression in a current round input by the user is obtained, subject-predicate-object components of the expression in the current round are detected through a preset rule. And whether the expression in the current round is in an omission form or not is judged. When the expression in the current round is in the omission form, the expression in the current round is combined with the expression in the previous round to understand to determine the intent of the user. When the expression in the current round is in a non-omission form, the expression in the current round is independently understood so as to determine the intent of the user.

However, a problem has been found by the inventor during the present application. That is, the above method still has the problem of inaccurate user semantic understanding, which results in low session efficiency and reduced user session experience. The problem mainly reflects in one or more of the following aspects.

(1) In the above prior art, whether the expression in the current round is combined with the expression in the previous round for understanding is judged only according to characteristics of the expression in the current round. A judgment result is low in accuracy due to accuracy of a voice recognition result and a diversity of user expressions. For example, although the expression in the current round is in an omission form, semantics of the expression in the current round and the expression in the previous round are not actually related. Alternatively, the expression in the current round is not in the omission form, but the expression in the current round is semantically related to the expression in the previous round.

(2) In actual applications, the user's intent may be clarified by more than two rounds of expressions, e.g. three, four, or even more rounds. In the above prior art, when the expression in the current round is determined to be in the omission form, the expression in the current round is only understood in association with the expression in the previous round. The user's semantics may still not be accurately understood from only the expression in the current round and the expression in the previous round.

(3) In actual applications, the intent expressed by the user may be vague or inaccurate due to the diversity of the user expressions. In these cases, when the above solution in the prior art is adopted, a failure may occur in retrieving an answer according to the user's semantics. This may result in that a corresponding response cannot be provided to the user, thereby rendering the user session experience low.

In order to solve at least one of the above problems, a human-machine dialog method is provided in the present application. The expression input by the user in each round is combined with previous historical expressions input by the user. A plurality pieces of candidate semantics of the user are determined, and a response query is generated according to the candidate semantics. Compared with the prior art, the accuracy of understanding the intent of the user is improved, and the session efficiency is improved. Therefore, the user session experience is improved.

The technical solutions of the present application will be described in detail with reference to several specific embodiments. These specific embodiments may be combined with each other, and details of the same or similar concepts or processes may not be repeated in some embodiments.

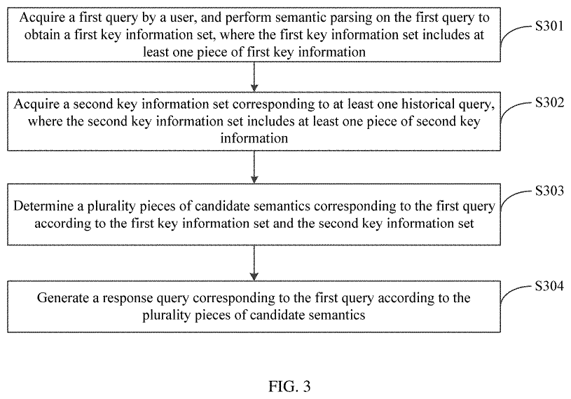

FIG. 3 is a schematic flowchart of a human-machine dialog method according to an embodiment of the present application. The method can be executed by a human-machine dialog apparatus, and can also be executed by a server which is in a communicational connection with the human-machine dialog apparatus. As shown in FIG. 3, the method includes the following steps.

Step 301: acquire a first query by a user, and perform semantic parsing on the first query to obtain a first key information set, where the first key information set includes at least one piece of first key information.

Step 302: acquire a second key information set corresponding to at least one historical query, where the second key information set includes at least one piece of second key information.

In the embodiment, for each expression input by the user, the step 301 to the step 304 will be executed. The first query may include an expression input by the user in a current round. The historical query may include an expression or several expressions input by the user in one or more rounds before the current round.

Optionally, the performing the semantic parsing on the first query to obtain the first key information set may include: obtaining an NLU parsing result by inputting the first query into an NLU model. The NLU parsing result may include the first key information set, and the first key information set may include at least one piece of first key information.

It should be noted that, the key information in the embodiment may be slot information in the NLU parsing result. That is, the first key information is slot information in the first query input in the current round, and the second key information is slot information in the historical query.

In the embodiment, the second key information set corresponding to the historical query may be maintained in a cache. The second key information set includes the second key information in the historical query. That is, the second key information set includes the slot information in the historical query. It should be appreciated that, in a multi-round session scenario, assuming that the first query currently input by the user is an expression in an N-th round, the second key information set includes slot information in historical queries of previous (N−1) rounds.

For example, suppose that queries input in the first two rounds are “play an English song” and “change to a hit one” respectively. When the user inputs the first query of “want a piece of jazz music” in the third round, semantic parsing is carried out on the first query “want a piece of jazz music”, and the first key information set which is {jazz} is obtained. And the second key information set acquired from the cache is {English, hit}. Further, when the user inputs a query in the fourth round, the second key information set in the cache is {English, hit, jazz}.

In the embodiment, by continuously updating and maintaining the second key information set in the cache, when the expression in the N-th round is subjected to semantic parsing, key information in expressions of the previous (N−1) rounds can be comprehensively considered, thus rendering semantic understanding of sessions with any length of N rounds accurate.

Step 303: determine a plurality pieces of candidate semantics corresponding to the first query according to the first key information set and the second key information set.

The plurality pieces of candidate semantics corresponding to the first query are multiple semantics that the user may want to express when inputting the first query.

By considering the first key information set and the second key information set comprehensively, the plurality pieces of candidate semantics may be determined. In the above example, suppose that the queries input in the first two rounds are “play an English song” and “change to a hit one” respectively. When the user inputs the first query of “want a piece of jazz music” in the third round, the user may want to listen to a piece of hit jazz music (no matter Chinese or English), or may want to listen to a piece of English jazz music (no matter hit or not), or may want to listen to a piece of hit jazz English music, or may want to listen to a piece of jazz music (no matter Chinese or English and no matter hit or not).

Optionally, in an optional implementation, a plurality of key information combination results may be obtained by performing combination processing on key information in the first key information set and the second key information set. Thus, a piece of candidate semantics of the user can be determined according to each of the key information combination results. Therefore, according to the plurality of key information combination results, the plurality pieces of candidate semantics of the user can be determined.

Optionally, when the semantic parsing is performed on the first query, the intent of the first query can be obtained. And the intent corresponding to at least one historical query is maintained in the cache. Thus, before the step 303, the method may further include: determining whether the intent of the first query is the same as or related to the intent of the historical query. When the two are the same or related, the step 303 and the step 304 are resumed. When the two are different or irrelevant, the first query is regarded as the expression input in the first round, and the first query can be processed by adopting an existing human-machine dialog method.

Step 304: generate a response query corresponding to the first query according to the plurality pieces of candidate semantics.

Illustratively, answer retrieval is carried out for each piece of candidate semantics. A response query corresponding to the first query is generated according to the answer retrieval of the plurality pieces of candidate semantics. For example, when an answer cannot be got for a piece of candidate semantics from the retrieval, the response query can be generated according to other candidate semantics.

It should be appreciated that, in the embodiment, since a plurality pieces of candidate semantics corresponding to the first query are determined, in this way, when the response query corresponding to the first query is generated, more reasonable response can be output to the user according to retrieval results of different candidate semantics. Thus, the session experience of the user is improved.

In the embodiment, a plurality pieces of candidate semantics corresponding to the first query are determined by analyzing the first key information set and the second key information set comprehensively. That is, the candidate semantics is obtained by parsing the first key information from the first query and the second key information from the historical query comprehensively. Since key information is important information for representing the semantics of the user, in the embodiment, a plurality pieces of candidate semantics of the first query are determined from the perspective of semantic relevance of the user's expressions in multiple rounds, in this way, accuracy of the semantic understanding can be improved.

Furthermore, in the embodiment, regardless of whether the first query is in the omission form, a comprehensive analysis is performed according to key information in history queries, rather than depending on whether the first query is in the omission form, in this way, the accuracy of the semantic understanding can be further improved.

The human-machine dialog method of the embodiment includes: acquiring a first query by a user, and perform semantic parsing on the first query to obtain a first key information set; acquiring a second key information set corresponding to at least one historical query; determining a plurality pieces of candidate semantics of the query according to the first key information set and the second key information set, and generating a response query corresponding to the first query according to the plurality pieces of candidate semantics. In the above process, the plurality pieces of candidate semantics of the user are determined according to the first key information set and the second key information set, the accuracy of user semantic understanding is improved, hence, a more reasonable response can be output to the user, and the user session experience is improved.

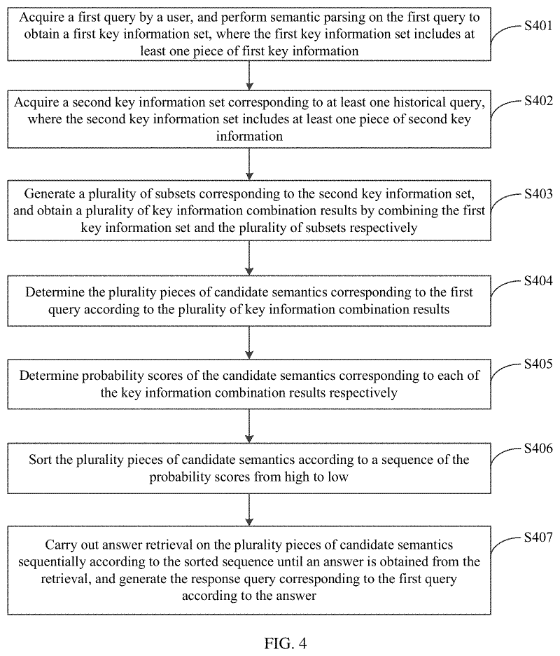

FIG. 4 is a schematic flowchart of another human-machine dialog method according to an embodiment of the present application. The implementation shown in FIG. 4 refines the implementation shown in FIG. 3. As shown in FIG. 4, the method may include the following steps.

Step 401: acquire a first query by a user, and perform semantic parsing on the first query to obtain a first key information set, where the first key information set includes at least one piece of first key information.

Step 402: acquire a second key information set corresponding to at least one historical query, where the second key information set includes at least one piece of second key information.

In the embodiment, implementations of the step 401 and the step 402 are similar to those of the step 301 and the step 302 shown in FIG. 3, and are not described herein.

Step 403: generate a plurality of subsets corresponding to the second key information set, and obtain a plurality of key information combination results by combining the first key information set and the plurality of subsets respectively.

Step 404: determine the plurality pieces of candidate semantics corresponding to the first query according to the plurality of key information combination results.

Illustratively, it is assumed that the first key information set is represented by query_slots, and the second key information set is represented by session_slots. It is assumed that the first key information set includes n pieces of first key information, that is:
query_slots={q_slot₁, q_slot₂, . . . , q_slotₙ}

The second key information set includes k pieces of second key information, that is:
session_slots={s_slot₁, s_slot₂, . . . , s_slotₖ}.

When the first key information in the first key information set and the second key information in the second key information set are combined, firstly, 2^{k} subsets of the second key information set session_slots are generated, which are respectively:
{ϕ}, {s_slot₁}, . . . , {s_slotₖ}, {s_slot₁, s_slot₂ 1, . . . }, . . . , {s_slot₁, s_slot₂, . . . , s_slotₘ} . . . , {s_slot₁, s_slot₂, . . . , s_slotₖ},
where m<k.

Then, each of the subsets is combined with the first key information set to obtain one key information combination result. Thus, 2^{k} key information combination results are obtained, which are respectively:
a key information combination result 1:
a combination of {ϕ} and {q_slot₁, q_slot₂, . . . , q_slotₙ};
a key information combination result 2:
a combination of {s_slot₁} and {q_slot₁, q_slot₂, . . . , q_slotₙ};
a key information combination result t:
a combination of {s_slot₁, s_slot₂, . . . , s_slotₘ} and {q_slot₁, q_slot₂, . . . , q_slotₙ}; and
a key information combination result 2^{k}:
a combination of {s_slot₁, s_slot₂, . . . , s_slotₖ} and {q_slot₁, q_slot₂, . . . , q_slotₙ}.

For example, assuming that n=2, k=2, the first key information set is {C, D}, and the second key information set is {A, B}, a total of four subsets are generated according to the second key information set, which are: {ϕ}, {A}, {B}, and {A, B}. By combining those four subsets with the first key information set respectively, four key information combination results are obtained, which are as follows: {ϕ, C, D}, {A, C, D}, {B, C, D}, and {A, B, C, D}.

It should be appreciated that, a piece of candidate semantics of the user can be determined according to each of the key information combination results. Thus, according to 2^{k} key information combination results, 2^{k} pieces of candidate semantics can be determined.

Step 405: determine probability scores of the candidate semantics corresponding to each of the key information combination results respectively.

In the embodiment, the probability score of one piece of candidate semantics indicates a probability that the candidate semantics is the user's true semantics. The higher the probability score, the greater the likelihood that the candidate semantics is the user's true semantics.

In an optional implementation, the probability score of the candidate semantics may be determined by the following method: for the first key information set and the subset in the second key information set in each of the key information combination results, calculating a conditional probability that the key information in the subset also appears under a condition that the key information in the first key information set appears; and taking the conditional probability as the probability score of the candidate semantic corresponding to the key information combination result.

Specifically, 2^{k} probability scores of the 2^{k} pieces of candidate semantics obtained by the step 403 and the step 404 are as follows:

Prob(ϕ|(q_slot₁,q_slot₂, . . . , q_slotₙ)); candidate semantics 1

Prob(s_slot₁|(q_slot₁,q_slot₂, . . . , q_slotₙ)); candidate semantics 2

Prob((s_slot₁,s_slot₂,s_slotₘ)|(q_slot₁,q_slot₂, . . . , q_slotₙ)); candidate semantics t

and

Prob((s_slot₁,s_slot₂, . . . , s_slotₘ)|(q_slot₁,q_slot₂, . . . , q_slotₙ)); candidate semantics 2^{k}

In a specific implementation, considering problems of statistical difficulty, normalization and the like, the probability score of each piece of candidate semantics is not calculated in a joint probability manner, but all key information is divided into binary relation groups for calculation. Two possible calculation methods are given below.

In a manner 1, the probability scores of the candidate semantics may be calculated as follows: acquiring a co-occurrence probability between each piece of first key information in the first key information set and each piece of second key information in the subset, and determining, according to the co-occurrence probability, the conditional probability that the subset also appears under the condition that the first key information set appears.

In the above method 1, when calculating the probability score of the candidate semantics, the co-occurrence probability between the first key information and the second key information in the key information combination results is utilized, thereby ensuring the accuracy of the probability score.

Further, in addition to the manner 1, when calculating the probability scores of the candidate semantic, a probability Pₗₑₓ that the first query is in the omission form may be considered, which is specifically as follows.

In a manner 2, the probability scores of each piece of candidate semantics may be calculated as follows: acquiring a probability that the first query is in an omission form; acquiring a co-occurrence probability between each piece of first key information in the first key information set and each piece of second key information in the subset; and determining, according to the probability that the first query is in the omission form and the co-occurrence probability, the conditional probability that the subset also appears under the condition that the first key information set appears.

In an optional implementation, the probability Pₗₑₓ that the first query is in the omission form can be predicted by inputting the first query into a Deep Neural Network (DNN) trained in advance. In the implementation, the probability that the first query is in the omission form is predicted by the DNN, in this way, accuracy of a prediction result is improved compared with the solution in the prior art where whether the first query is in the omission form is judged by detecting subject-predicate-object components according to a preset rule.

In the above manner 2, when calculating the probability score of the candidate semantics, not only the co-occurrence probability between the first key information and the second key information in the key information combination result is used, but also the probability that the first query is in the omission form is taken into account. So that the accuracy of the probability score of the candidate semantics is further improved.

In the following, taking the manner 2 as an example, a calculation process of the probability score of the candidate semantics is exemplified.

Illustratively, a calculation for the probability score of the candidate semantic 2 is:

$$Prob ( {s\_lot}_{1} \vert ( {q\_slot}_{1} , {q\_slot}_{2} , … , {q\_slot}_{n} ) ) = P \text{?} {\prod }_{i = 1}^{n} P ( {s\_slot}_{1} \vert q\_slot \text{?} ) \text{?} {\prod }_{j = 2}^{\text{?}} {\prod }_{i = 1}^{n \text{?}} ( 1 - P ( {s\_slot}_{j} \vert {q\_slot}_{\text{?}} ) )$$

$$\text{?} \text{indicates text missing or illegible when filed}$$

Illustratively, a calculation for the probability score of the candidate semantic t is:

$$Prob ( ( {s\_lot}_{1} , {s\_slot}_{2} , … , {s\_slot}_{\text{?}} ) \vert ( {q\_slot}_{1} , {q\_slot}_{2} , … , {q\_slot}_{n} ) ) = P \text{?} {\prod }_{\text{?}}^{\text{?}} {\prod }_{\text{?}}^{\text{?}} P ( {s\_slot}_{j} \vert q\_slot \text{?} ) \text{?} {\prod }_{j \text{?}}^{\text{?}} {\prod }_{i = 1}^{\text{?}} ( 1 - P ( {s\_slot}_{j} \vert {q\_slot}_{\text{?}} ) ) \\ \text{?} \text{indicates text missing or illegible when filed}$$

In the above two examples, P(s_slotⱼ|q_slotᵢ) represents the conditional probability that s_slotⱼ also appears when q_slotᵢ appears. The conditional probability can be calculated from the co-occurrence probability P(s_slotⱼ, q_slotᵢ) and the probability P(qₛₗₒₜ_{ᵢ}) of q_slotᵢ, that is,

$$P ( {s\_slot}_{j} \vert {q\_slot}_{i} ) = \frac{P ( {s\_slot}_{j} , {q\_slot}_{i} )}{P ( {q\_slot}_{i} )}$$

In the embodiment, when calculating the probability score of the candidate semantics, the co-occurrence probability between the first key information and the second key information in the key information combination result is utilized. The co-occurrence probability is obtained by making off-line statistics on a large number of historical corpora. Hence the accuracy of the probability score of the candidate semantics is improved.

Specifically, the following feasible ways can be adopted: acquiring a historical corpus and generating a key information co-occurrence database according to the historical corpus, where the key information co-occurrence database comprises co-occurrence probabilities among different key information; and obtaining the co-occurrence probability between the first key information and the second key information by inquiring the key information co-occurrence database.

It should be noted that, the generation process of the key information co-occurrence database is not limited in the embodiment, and reference may be made to detailed descriptions in subsequent embodiments for a possible implementation.

Step 406: sort the plurality pieces of candidate semantics according to a sequence of the probability scores from high to low.

Step 407: carry out answer retrieval on the plurality pieces of candidate semantics sequentially according to the sorted sequence until an answer is obtained from the retrieval, and generate the response query corresponding to the first query according to the answer.

It should be appreciated that, the plurality pieces of candidate semantics is sorted according to the sequence of the probability scores from high to low, thus, the candidate semantics in the front of the sequence may be close to the user's true semantics. Therefore, answer retrieval may be carried out on the plurality pieces of candidate semantics sequentially according to the sorted sequence until an answer is obtained from the retrieval. And then the response query corresponding to the first query is generated according to the answer.

Illustratively, according to a sequencing result, the first candidate semantic is preferentially retrieved to determine whether an answer can be obtained. If yes, the response query corresponding to the first query is generated according to the answer. If not, the second candidate semantic is continuously retrieved. And repeating the steps until the answer is retrieved. Then, the response query is generated according to the retrieved answer.

Optionally, before sorting the candidate semantics, a preset threshold can be used to filter the probability scores, so that only the candidate semantics with a probability score larger than the preset threshold need to be sorted.

The following describes a process for generating the key information co-occurrence database in connection with a specific embodiment.

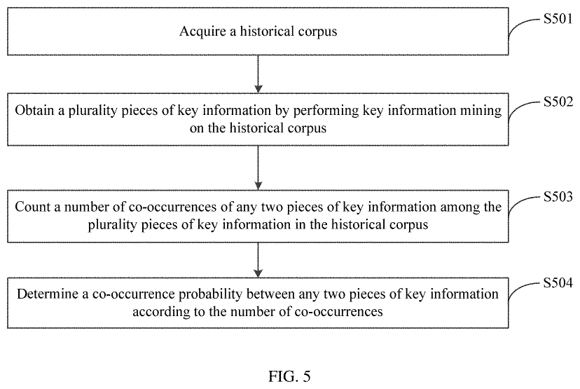

FIG. 5 is a schematic view of a generating process for a key information co-occurrence database according to an embodiment of the present application. As shown in FIG. 5, the method may include the following steps.

Step 501: acquire a historical corpus.

The historical corpus includes but is not limited to a search log, a session log, and the like.

Step 502: obtain a plurality pieces of key information by performing key information mining on the historical corpus.

Specifically, the plurality of key information can be obtained by inputting the historical corpus into a key information detection model trained in advance. The model labels the key information in the historical corpus and obtains the plurality of key information according to labeling results.

For example, suppose that a certain historical corpus is “a song of lovely balloon by Xiao Hong”. Key information in this historical corpus is labeled by the model, and a corresponding labeling result is: the singer=“Xiao Hong”, the song=“lovely balloon”. Thus the key information of “Xiao Hong” and “lovely balloon” is obtained.

Step 503: count a number of co-occurrences of any two pieces of key information among the plurality pieces of key information in the historical corpus.

Step 504: determine a co-occurrence probability between any two pieces of key information according to the number of co-occurrences.

According to the labeling results, the number of co-occurrences of any two pieces of key information in the historical corpus can be counted, that is, times that any two pieces of key information appear in the same corpus. For example, counting to obtain the number of co-occurrences of “Xiao Hong” and “lovely balloon”, the number of co-occurrences is divided by a total number of the corpora. Thus the co-occurrence probability between “Xiao Hong” and “lovely balloon” is obtained.

Further, a process of the embodiment may be performed offline. A co-occurrence probability database is generated by storing the co-occurrence probabilities of different key information obtained statistically in the embodiment into a database. Therefore, when semantic understanding of the first query needs to be carried out on line, the co-occurrence probability among required key information can be obtained by inquiring the co-occurrence probability database, thus improving the efficiency of semantic understanding.

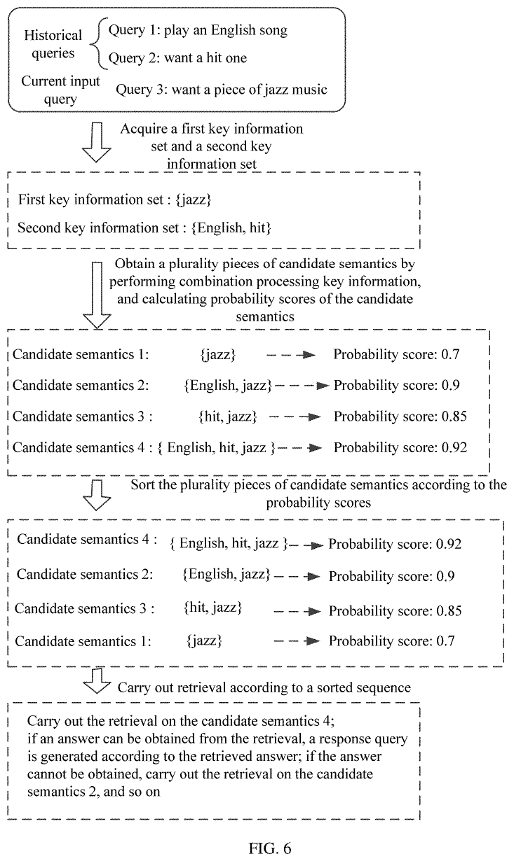

FIG. 6 is a schematic view of a process for a human-machine dialog processing according to an embodiment of the present application. The following describes a process of the human-machine dialog in connection with a specific embodiment.

Suppose that historical queries input by a user to a human-machine dialog apparatus include “play an English song” and “want a hit one”. When the user inputs a query of “want a piece of jazz music” to the human-machine dialog apparatus, a process for executing the current input query by the human-machine dialog apparatus is shown in FIG. 6.

Referring to FIG. 6, the human-machine dialog apparatus performs semantic parsing on the current input query, and obtains a first key information set of {jazz}. The human-machine dialog apparatus obtains a second key information set of {English, hit} corresponding to the historical queries from a cache. Specifically, reference may be made to detailed descriptions of the step 301 and the step 302 in FIG. 3 for an acquiring process of the first key information set and the second key information set.

Referring to FIG. 6 continuously, the human-machine dialog apparatus obtains a plurality of key information combination results by performing combination processing on key information in the first key information set and the second key information set. And each of the key information combination results corresponds to one piece of candidate semantics. Further, probability scores of each piece of the candidate semantics may be determined. Suppose that the candidate semantics and corresponding probability scores are as follows:
candidate semantics 1: {jazz} with a probability score of 0.7;
candidate semantics 2: {English, jazz} with a probability score of 0.9;
candidate semantics 3: {hit, jazz} with a probability score of 0.85; and
candidate semantics 4: {English, hit, jazz} with a probability score of 0.92.

Reference may be made to detailed descriptions of the step 403 and the step 404 in FIG. 4 for a combination process of the key information, and reference may be made to detailed descriptions of the step 405 in FIG. 4 for the probability scores of the candidate semantics.

Referring to FIG. 6 continuously, the human-machine dialog apparatus sorts the plurality pieces of candidate semantics according to a sequence of the probability scores from high to low. The sorted sequence is: the candidate semantics 4—the candidate semantics 2—the candidate semantics 3—the candidate semantics 1.

Further, the human-machine dialog apparatus carries out answer retrieval on the candidate semantics sequentially according to the sorted sequence. Illustratively, the human-machine dialog apparatus may carry out the answer retrieval on the candidate semantics 4. If an answer can be obtained from the retrieval, response query is generated according to the retrieved answer. If the answer cannot be obtained from the retrieval, the human-machine dialog apparatus may carry out the answer retrieval on the candidate semantics 2. If the answer can be obtained from the retrieval, response query is generated according to the retrieved answer. If the answer cannot be obtained from the retrieval, the human-machine dialog apparatus may carry out the answer retrieval on the candidate semantics 3, and so on.

In the above process, by determining a plurality pieces of candidate semantics of the user according to the first key information set and the second key information set, the accuracy of user semantic understanding is improved. According to retrieval results of different candidate semantics, a more reasonable response query can be output to the user and the user session experience is improved.

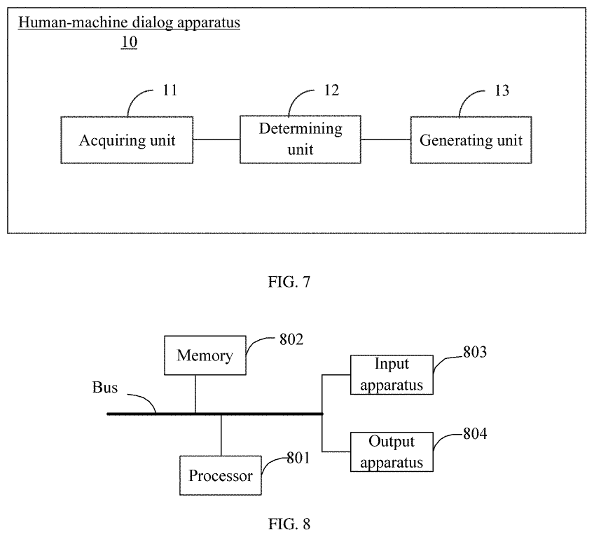

FIG. 7 is a structural diagram of a human-machine dialog apparatus according to an embodiment of the present application. The apparatus may be in a form of software or hardware. As shown in FIG. 7, the human-machine dialog apparatus 10 may include an acquiring unit 11, a determining unit 12 and a generating unit 13.

The acquiring unit 11 is configured to acquire a first query by a user, and perform semantic parsing on the first query to obtain a first key information set, where the first key information set includes at least one piece of first key information. And the acquiring unit 11 is further configured to acquire a second key information set corresponding to at least one historical query, where the second key information set includes at least one piece of second key information.

The determining unit 12 is configured to determine a plurality pieces of candidate semantics corresponding to the first query according to the first key information set and the second key information set.

The generating unit 13 is configured to generate a response query corresponding to the first query according to the candidate semantics.

In an optional implementation, the determining unit 12 is specifically configured to:
obtain a plurality of key information combination results by performing combination processing on key information in the first key information set and the second key information set; and
determine the plurality pieces of candidate semantics corresponding to the first query according to the key information combination results, where the plurality of key information combination results have a one to one correspondence with the plurality pieces of candidate semantics.

In an optional implementation, the determining unit 12 is specifically configured to:
generate a plurality of subsets corresponding to the second key information set; and
obtain the plurality of key information combination results by combining the first key information set and plurality of the subsets respectively.

In an optional implementation, the generating unit 13 is specifically configured to:
determine probability scores of the candidate semantics corresponding to each of the key information combination results respectively;
sort the plurality pieces of candidate semantics according to a sequence of the probability scores from high to low; and
carry out answer retrieval on the plurality pieces of candidate semantics sequentially according to the sorted sequence until an answer is obtained from the retrieval, and generate the response query corresponding to the first query according to the answer.

In an optional implementation, the generating unit 13 is specifically configured to:
determine, according to the first key information set and the subset in the key information combination result, a conditional probability that the subset also appears under a condition that the first key information set appears; and take the conditional probability as the probability score of the candidate semantics corresponding to the key information combination result.

In an optional implementation, the generating unit 13 is specifically configured to:
acquire a co-occurrence probability between each piece of first key information in the first key information set and each piece of second key information in the subset; and
determine, according to the co-occurrence probability, the conditional probability that the subset also appears under the condition that the first key information set appears.

In an optional implementation, the generating unit 13 is specifically configured to:
acquire a probability that the first query is in an omission form;
acquire a co-occurrence probability between each piece of first key information in the first key information set and each piece of second key information in the subset; and
determine, according to the probability that the first query is in the omission form and the co-occurrence probability, the conditional probability that the subset also appears under the condition that the first key information set appears.

In an optional implementation, the generating unit 13 is specifically configured to:
acquire a historical corpus and generate a key information co-occurrence database according to the historical corpus, where the key information co-occurrence database comprises co-occurrence probabilities among different key information; and
obtain the co-occurrence probability between each piece of first key information in the first key information set and each piece of second key information in the subset by inquiring the key information co-occurrence database.

In an optional implementation, the generating unit 13 is specifically configured to:

obtain a plurality pieces of key information by performing key information mining on the historical corpus;
count a number of co-occurrences of any two pieces of key information among the plurality pieces of key information in the historical corpus; and
determine a co-occurrence probability between any two pieces of key information according to the number of co-occurrences.

The human-machine dialog apparatus may be applied to implement technical solutions in any one of the method embodiments described above. The implementation principles and technical effects thereof are similar, and are not described herein.

According to an embodiment of the present application, the present application provides an electronic device and a readable storage medium.

FIG. 8 is a structural diagram of an electronic device for executing a human-machine dialog method according to an embodiment of the present application. The electronic device is intended to represent various forms of digital computers, such as laptops, desktops, workstations, personal digital assistants, servers, blade servers, mainframes, and other appropriate computers. The electronic device may also represent various forms of mobile devices, such as personal digital processors, cellular telephones, smart phones, wearable devices, and other similar computing devices. The components shown herein, their connections and relationships, and their functions, are meant to be examples only, and are not intended to limit implementations of the applications described or claimed herein.

As shown in FIG. 8, the electronic device may include: one or more processors 801, a memory 802, and interfaces for connecting the components. The interfaces include a high speed interface and a low speed interface. The various components are interconnected using different buses and may be mounted on a common motherboard or in other manners as desired. The processor may process instructions executed within the electronic device, including instructions stored in the memory or on the memory for displaying graphical information of a graphical user interface (GUI) on an external input/output apparatus (such as a display device coupled to the interface). In other embodiments, multiple processors and/or multiple buses may be used, along with multiple memories, if desired. Also, multiple electronic devices may be connected, with each electronic device providing some necessary operations (e.g. as a server array, a group of blade servers, or a multi-processor system). The processor 801 is taken as an example in FIG. 8.

The memory 802 is a non-transitory computer readable storage medium as provided herein. The memory stores instructions executable by at least one processor to cause at least one processor to perform a human-machine dialog method provided herein. The non-transitory computer-readable storage medium of the present application stores computer instructions for causing a computer to execute the human-machine dialog method provided by the present application.

The memory 802, as a non-transitory computer-readable storage medium, may be used to store non-transitory software programs, non-transitory computer-executable programs, and modules, such as program instructions or modules (e.g. an acquiring unit 11, a determining unit 12 and a generating unit 13 shown in FIG. 7) corresponding to the human-machine dialog method in the embodiments of the present application. The processor 801 executes various functional applications of the server and data processing by running non-transitory software programs, instructions, and modules stored in the memory, i.e. implementing the human-machine dialog method in the above method embodiments.

The memory 802 may include a program storage area and a data storage area. The program storage area may store an operating system, an application program required for at least one function. The data storage area may store data created by use of the electronic device according to the embodiments of the present application, and the like. Further, the memory 802 may include a high speed random access memory, and may also include a non-transitory memory, such as at least one magnetic disk storage device, flash memory device, or other non-transitory solid state storage device. In some embodiments, the memory 802 optionally includes a memory located remotely from the processor 801, which may be connected to the electronic device via a network. Examples of such networks include, but are not limited to, the internet, intranets, local area networks, mobile communication networks, and combinations thereof.

The electronic device used for implementing the human-machine dialog method may also include an input apparatus 803 and an output apparatus 804. The processor 801, the memory 802, input apparatus 803 and the output apparatus 804 may be interconnected by buses or in other manners. Interconnection by buses are taken as an example in FIG. 8.

The input device 803 may receive input numeric or character information and generate key signal inputs related to user settings and function controls of the electronic device for human-machine dialog, which may be a touch screen, a keypad, a mouse, a track pad, a touch pad, a pointing stick, one or more mouse buttons, a track ball, a joystick, or other input devices. The output devices 804 may include a display device, auxiliary lighting apparatuses (e.g. Light Emitting Diodes (LEDs)), and tactile feedback apparatuses (e.g. vibrating motors), and the like. The display device may include, but is not limited to, a Liquid Crystal Display (LCD), an LED display, and a plasma display. In some embodiments, the display device can be a touch screen.

Various implementations of the systems and techniques described here can be realized in a digital electronic circuitry, an integrated circuitry, an application specific ASICs (application specific integrated circuits), a computer hardware, a firmware, software, and combinations thereof. These various embodiments may include the implementations implemented in one or more computer programs that are executable and/or interpretable on a programmable system including at least one programmable processor. The programmable processor may be special or general, and may receive data and instructions from, and transmit data and instructions to, a storage system, at least one input apparatus, and at least one output apparatus.

These computer programs (also known as programs, software, software applications, or codes) include machine instructions for a programmable processor, and may be implemented using high-level procedural and subtended programming languages, or assembly/machine languages. As used herein, the terms “machine-readable medium” and “computer-readable medium” refer to any computer program product, device and/or apparatus (e.g. magnetic discs, optical disks, memory, Programmable Logic Devices (PLDs)) used to provide machine instructions and/or data to the programmable processor. The terms include a machine-readable medium that receives machine instructions as a machine-readable signal. The term “machine-readable signal” refers to any signal used to provide machine instructions and/or data to the programmable processor.

To provide for interaction with a user, the systems and techniques described here can be implemented on a computer. The computer has: a display apparatus (e.g. a CRT (cathode ray tube) or an LCD (liquid crystal display) monitor) for displaying information to a user; and a keyboard and a pointing apparatus (e.g. a mouse or a trackball). A user may provide input to the computer through the keyboard and the pointing apparatus. Other kinds of apparatuses may also be used to provide for interaction with the user. For example, feedback provided to the user can be any form of sensory feedback (e.g. visual feedback, auditory feedback, or tactile feedback). And input from the user can be received in any form, including acoustic, speech, or tactile input.

The systems and techniques described here can be implemented in a computing system that includes a back-end component (e.g. as a data server), or that includes a middleware component (e.g. an application server), or that includes a front-end component (e.g. a user computer having a graphical user interface or a web browser through which a user can interact with an implementation of the systems and techniques described here), or any combination of such back-end, middleware, or front-end components. The components of the systems can be interconnected by any form or medium of digital data communication (e.g. a communication network). Examples of communication networks include: local area networks (LANs), wide area networks (WAN), and the internet.

A computing system may include a client and a server. The client and the server are generally located remotely from each other and typically interact through a communication network. The relationship of client and server arises by virtue of computer programs running on respective computers and having a client-server relationship therebetween.

It should be appreciated that, steps may be reordered, added, or deleted according to the various processes described above. For example, the steps described in the present application may be executed in parallel, sequentially, or in different orders, which are not limited herein as long as the desired results of the technical solutions disclosed in the present application can be achieved.

What are stated above are simply preferred embodiments of the present application and not intended to limit the present application. A person skilled in the art may appreciate that modifications, combinations, sub-combinations and substitutions can be made according to design requirements and other factors. Any modifications, equivalent substitutions and improvements made within the spirit and the principle of the present application all should be included in the extent of protection of the present application.

What is claimed is:

1. A human-machine dialog method, comprising:
acquiring a first query by a user, and perform semantic parsing on the first query to obtain a first key information set, wherein the first key information set comprises at least one piece of first key information;
acquiring a second key information set corresponding to at least one historical query, wherein the second key information set comprises at least one piece of second key information;
determining a plurality pieces of candidate semantics corresponding to the first query according to the first key information set and the second key information set; and
generating a response query corresponding to the first query according to the plurality pieces of candidate semantics.

2. The method according to claim 1, wherein the determining a plurality pieces of candidate semantics corresponding to the first query according to the first key information set and the second key information set comprises:
obtaining a plurality of key information combination results by performing combination processing on key information in the first key information set and the second key information set; and
determining the plurality pieces of candidate semantics corresponding to the first query according to the plurality of key information combination results, wherein the plurality of key information combination results have a one to one correspondence with the plurality pieces of candidate semantics.

3. The method according to claim 2, wherein the obtaining a plurality of key information combination results by performing combination processing on key information in the first key information set and the second key information set comprises:
generating a plurality of subsets corresponding to the second key information set; and
obtaining the plurality of key information combination results by combining the first key information set and the plurality of subsets respectively.

4. The method according to claim 3, wherein the generating a response query corresponding to the first query according to the plurality pieces of candidate semantics comprises:
determining probability scores of the candidate semantics corresponding to each of the key information combination results respectively;
sorting the plurality pieces of candidate semantics according to a sequence of the probability scores from high to low; and
carrying out answer retrieval on the plurality pieces of candidate semantics sequentially according to the sorted sequence until an answer is obtained from the retrieval, and generating the response query corresponding to the first query according to the answer.

5. The method according to claim 4, wherein the determining probability scores of the candidate semantics corresponding to each of the key information combination results respectively comprises:
for each of the key information combination results, determining, according to the first key information set and the subset in the key information combination result, a conditional probability that the subset also appears under a condition that the first key information set appears; and taking the conditional probability as the probability score of the candidate semantic corresponding to the key information combination result.

6. The method according to claim 5, wherein the determining, according to the first key information set and the subset in the key information combination result, a conditional probability that the subset also appears under a condition that the first key information set appears comprises:
acquiring a co-occurrence probability between each piece of first key information in the first key information set and each piece of second key information in the subset; and
determining, according to the co-occurrence probability, the conditional probability that the subset also appears under the condition that the first key information set appears.

7. The method according to claim 5, wherein the determining, according to the first key information set and the subset in the key information combination result, a conditional probability that the subset also appears under a condition that the first key information set appears comprises:
acquiring a probability that the first query is in an omission form;
acquiring a co-occurrence probability between each piece of first key information in the first key information set and each piece of second key information in the subset; and
determining, according to the probability that the first query is in the omission form and the co-occurrence probability, the conditional probability that the subset also appears under the condition that the first key information set appears.

8. The method according to claim 6, wherein the acquiring a co-occurrence probability between each piece of first key information in the first key information set and each piece of second key information in the subset comprises:
acquiring a historical corpus and generating a key information co-occurrence database according to the historical corpus, wherein the key information co-occurrence database comprises co-occurrence probabilities among different key information; and
obtaining the co-occurrence probability between each piece of first key information in the first key information set and each piece of second key information in the subset by inquiring the key information co-occurrence database.

9. The method according to claim 8, wherein the generating a key information co-occurrence database according to the historical corpus comprises:
obtaining a plurality pieces of key information by performing key information mining on the historical corpus;
counting a number of co-occurrences of any two pieces of key information among the plurality pieces of key information in the historical corpus; and
determining a co-occurrence probability between any two pieces of key information according to the number of co-occurrences.

10. A human-machine dialog apparatus, comprising:
at least one processor; and
a memory communicatively coupled to the at least one processor, wherein the memory is stored with instructions executable by the at least one processor, the instructions are executed by the at least one processor to cause the at least one processor to perform steps of:
acquiring a first query by a user, and perform semantic parsing on the first query to obtain a first key information set, wherein the first key information set comprises at least one piece of first key information;
acquiring a second key information set corresponding to at least one historical query, wherein the second key information set comprises at least one piece of second key information;
determining a plurality pieces of candidate semantics corresponding to the first query according to the first key information set and the second key information set; and
generating a response query corresponding to the first query according to the plurality pieces of candidate semantics.

11. The apparatus according to claim 10, wherein the instructions are executed by the at least one processor to cause the at least one processor to perform steps of:
obtaining a plurality of key information combination results by performing combination processing on key information in the first key information set and the second key information set; and
determining the plurality pieces of candidate semantics corresponding to the first query according to the plurality of key information combination results, wherein the plurality of key information combination results have a one to one correspondence with the plurality pieces of candidate semantics.

12. The apparatus according to claim 11, wherein the instructions are executed by the at least one processor to cause the at least one processor to perform steps of:
generating a plurality of subsets corresponding to the second key information set; and
obtaining the plurality of key information combination results by combining the first key information set and the plurality of subsets respectively.

13. The apparatus according to claim 12, wherein the instructions are executed by the at least one processor to cause the at least one processor to perform steps of:
determining probability scores of the candidate semantics corresponding to each of the key information combination results respectively;
sorting the plurality pieces of candidate semantics according to a sequence of the probability scores from high to low; and
carrying out answer retrieval on the plurality pieces of candidate semantics sequentially according to the sorted sequence until an answer is obtained from the retrieval, and generate the response query corresponding to the first query according to the answer.

14. The apparatus according to claim 13, wherein the instructions are executed by the at least one processor to cause the at least one processor to perform steps of:
for each of the key information combination results, determining, according to the first key information set and the subset in the key information combination result, a conditional probability that the subset also appears under a condition that the first key information set appears; and taking the conditional probability as the probability score of the candidate semantics corresponding to the key information combination result.

15. The apparatus according to claim 14, wherein the instructions are executed by the at least one processor to cause the at least one processor to perform steps of:
acquiring a co-occurrence probability between each piece of first key information in the first key information set and each piece of second key information in the subset; and
determining, according to the co-occurrence probability, the conditional probability that the subset also appears under the condition that the first key information set appears.

16. The apparatus according to claim 14, wherein the instructions are executed by the at least one processor to cause the at least one processor to perform steps of:
acquiring a probability that the first query is in an omission form;
acquiring a co-occurrence probability between each piece of first key information in the first key information set and each piece of second key information in the subset; and
determining, according to the probability that the first query is in the omission form and the co-occurrence probability, the conditional probability that the subset also appears under the condition that the first key information set appears.

17. The apparatus according to claim 15, wherein the instructions are executed by the at least one processor to cause the at least one processor to perform steps of:
acquiring a historical corpus and generate a key information co-occurrence database according to the historical corpus, wherein the key information co-occurrence database comprises co-occurrence probabilities among different key information; and
obtaining the co-occurrence probability between each piece of first key information in the first key information set and each piece of second key information in the subset by inquiring the key information co-occurrence database.

18. The apparatus according to claim 16, wherein the instructions are executed by the at least one processor to cause the at least one processor to perform steps of:
acquiring a historical corpus and generate a key information co-occurrence database according to the historical corpus, wherein the key information co-occurrence database comprises co-occurrence probabilities among different key information; and
obtaining the co-occurrence probability between each piece of first key information in the first key information set and each piece of second key information in the subset by inquiring the key information co-occurrence database.

19. The apparatus according to claim 17, wherein the instructions are executed by the at least one processor to cause the at least one processor to perform steps of:
obtaining a plurality pieces of key information by performing key information mining on the historical corpus;
counting a number of co-occurrences of any two pieces of key information among the plurality pieces of key information in the historical corpus; and
determining a co-occurrence probability between any two pieces of key information according to the number of co-occurrences.

20. A non-transitory computer readable storage medium having computer instructions stored thereon, the computer instructions are configured to cause a computer to perform a method according to claim 1.
